(19) United States
(12) Patent Application Publication
(10) Pub. No.: US 2025/0347863 A1
(43) Pub. Date: Nov. 13, 2025

(54) EDGE COUPLER BEAM DEFLECTION SYSTEM

(71) Applicant: XILINX, INC., San Jose, CA (US)

(72) Inventors: Hao-Hsiang LIAO, San Jose, CA (US); Chuan XIE, Fremont, CA (US); Suresh RAMALINGAM, Fremont, CA (US)

(21) Appl. No.: 18/658,906

(22) Filed: May 8, 2024

(51) Int. Cl. G02B 6/42

(52) U.S. Cl. CPC G02B 6/4214; G02B 6/4292

(57) ABSTRACT

Embodiments herein describe a system including a first optical device disposed adjacent a photonics integrated circuit (PIC), wherein the first optical device includes a first mirror to receive a light beam from the PIC and deflect the light beam in a first direction, a second optical device including a second mirror to receive the light beam deflected in the first direction and deflect the light beam deflected in the first direction toward a second direction, and a multi-channel fiber array to receive the light beam deflected in the second direction.

### TECHNICAL FIELD

Examples of the present disclosure generally relate to photonic integrated circuit (PIC) couplers used in photonics packaging technology, and in particular, to an edge coupler beam deflection system.

### BACKGROUND

Photonics packaging technology refers to methods and techniques used to assemble, protect, and integrate photonic components and devices into functional systems. Photonics, which involves the generation, manipulation, and detection of light, encompasses various applications such as telecommunications, medical devices, sensors, and imaging systems. Photonics packaging plays an important role in ensuring the reliability, performance, and longevity of these systems and devices.

### SUMMARY

One embodiment described herein is a system including a first optical device disposed adjacent a photonics integrated circuit (PIC), where the first optical device includes a first mirror to receive a light beam from the PIC and deflect the light beam in a first direction, a second optical device including a second mirror to receive the light beam deflected in the first direction and deflect the light beam deflected in the first direction toward a second direction, and a multi-channel fiber array to receive the light beam deflected in the second direction.

One embodiment described herein is an edge coupler including a first optical device that includes a first mirror to deflect a light beam in a first direction, a second optical device that includes a second mirror to receive and deflect the light beam in the first direction toward a second direction, and an optical connector to receive the light beam deflected in the second direction via a multi-channel fiber array. The light may travel reversely and follow the exact same path which can treat the PIC as a transmitter and/or a receiver component.

One embodiment described herein is a method including receiving, by a first optical device having a first mirror, a light beam from a photonics integrated circuit (PIC), deflecting the light beam in a first direction, receiving, by a second optical device having a second mirror, the light beam deflected in the first direction toward a second direction, and receiving the light beam deflected in the second direction via a multi-channel fiber array.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates an edge coupler beam deflection system, according to an example.

FIG. 2 illustrates the details of the fixed piece of the edge coupler beam deflection system of FIG. 1, according to an example.

FIG. 3 illustrates a method for implementing the edge coupler beam deflection system, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Modern telecommunications require significant technological advancements to cope with the tremendous growth of data exchanged over networks, which is mainly driven by mobile applications, video streaming, and cloud services. Optical technologies have already revolutionized the communications field, allowing for modern high-bandwidth transoceanic transmission through optical fibers. Over the last decade, silicon (Si) photonics have been established as a platform for the realization of optical transceivers and optical processors, aiming to provide low-cost and high-performance components for telecom and datacom applications. Using Si waveguides as a basic element, a variety of optical components can be implemented.

Although Si photonics can now be considered as a mature technological platform, its compatibility with optical fiber components is still relatively limited, mainly due to optical mode size mismatch between the optical fibers and silicon photonic waveguide. Because of this, coupling light into and from silicon photonic components with large efficiencies is still a relevant challenge. To overcome this issue, coupler design on PIC becomes important.

PICs are miniaturized optical devices that integrate multiple photonic components and functions on a single semiconductor chip or substrate. Similar to electronic integrated circuits (ICs), which integrate electronic components such as transistors, resistors, and capacitors onto a single chip, PICs integrate various optical components such as, but not limited to, lasers, waveguides, modulators, detectors, and filters.

There are two main types of PIC couplers, that is, a grating coupler (GC) and an edge coupler (EC). The example embodiments focus on edge couplers.

In the GC, light is coupled from an in-plan waveguide to a diffractive grating structure on a PIC surface so that a light beam can be deflected to an out-of-plane direction from an in-plane direction. Light in the EC exhibits the same emitted direction as the in-plane waveguide that is coupled into a spot size converter and propagated in the same plane. An advantage of the GC is that light coming out-of-plane is more convenient for wafer-level testing. However, the GC has a narrower bandwidth (in wavelength) and a higher coupler loss compared to the EC. On the contrary, the EC is suitable for wider bandwidth applications with lower coupler loss and lower polarization dependency compared to the GC.

A challenging limitation regarding a GC is bandwidth (in wavelength). The GC usually puts more of a restriction on laser center wavelength and laser channel spacing accuracy. The more numbers of wavelength used, the more accuracy is needed to match the GC's nominal center wavelength in a small tolerance, as well as to serve large amounts of wavelength channel numbers within small channel spacing tolerance. In contrast, the EC is a wide bandwidth application and there is no restriction in wavelength and channel spacing. Because of this difference in optical bandwidth, the EC is the preferred or most viable coupling scheme for wavelength division multiplexing (WDM) where multiple wavelengths spanning a wide spectral range are carried in the same fiber.

Edge coupling can also be referred to as “in-plane,” “end-fire,” or “butt” coupling. In this case, the light beam is coupled in/out from the waveguide from lateral sides, thus always propagating in the same plane. This technique typically uses optical-quality facets on the chip sides in order to allow for high coupling efficiencies (e.g., greater than 80%), with negligible polarization dependence.

Stated differently, in photonics, an edge coupler is a type of optical coupler used to efficiently couple light between a waveguide on a photonic device and an-optical fiber or thru an external optical component or system to a fiber. The term “edge” in edge coupler refers to the location where light is coupled into or out of the photonic device, typically at the edge of a waveguide.

Edge couplers are commonly used in integrated photonic circuits, where they facilitate the transfer of optical signals between on-chip components and off-chip optical fibers or other photonic devices. Edge couplers are particularly useful for interfacing between the planar waveguides commonly used in integrated photonics and the external optical components or systems used for signal generation, detection, or transmission. The design of an edge coupler is optimized to achieve efficient coupling of light while minimizing losses and reflections.

In advanced heterogeneous packaging technology (e.g., 2.5D or 3D die-stacking structures), the active side of the PIC die is often flipped onto a silicon interposer, an organic substrate, or another IC die. In this case, a small distance between the edge coupler and the surface the PIC is typically less than 100 μm and may not provide enough mechanical clearance to accommodate a coupling lens.

In view thereof, the example embodiments provide for an edge coupler beam deflection system including a fixed piece and a detachable piece. Both fixed pieces and detachable pieces will be glass molded to ensure precise manufacture tolerances and are composed of curved mirrors for beam collimation and refocusing back to the PIC and fiber core. The fixed piece is disposed adjacent the PIC and the detachable piece is disposed directly over the fixed piece. The fixed piece includes a first mirror and the detachable piece includes a second mirror, where the first mirror and the second mirror are curved mirrors or concave mirrors. The detachable piece is assembled with a multi-channel fiber ribbon array, which is terminated to an optical connector. The detachable piece with the multi-channel fiber array and connector are collectively referred to as a fiber array unit (FAU). Two contact surfaces of fix pieces and detachable pieces can include anti-reflection coatings to reduce reflection and improve optical efficiencies.

In the example embodiments, the first mirror of the fixed piece is secured at a 45° angle that is more tolerable to the clearance between the edge coupler and the PIC. The edge coupler beam deflection system also allows modifying the optical path from horizontal to vertical so that both GC and EC can potentially share the same type of FAU. As such, the techniques developed for GC can be applied with little or no modification. The fixed piece can be made from various transparent materials with a refractive index similar to glass. The first mirror (or array of mirrors if multiple channels are employed) can be formed by molding or stamping, and its reflecting surface can be metal-coated and made concave with proper curvature so that the beam from the EC can be collimated while being directed upwards toward the detachable piece. The desired beam size can be achieved by choosing the right distance between the first mirror and the EC facet based on the divergence of the beam from the EC. In addition, the top surface of the fixed piece has a larger area and fiducials/marks, compared to a sidewall interface, to support the detachable FAU. The example embodiments also advantageously provide for proper edge coupler alignment, which is an important aspect in the fabrication and assembly of the first optical device (fixed piece) and the second optical device (detachable piece). The example embodiments also advantageously provide for simplifying EC photonics packaging solutions by providing optical components that can be detachably incorporated to existing systems.

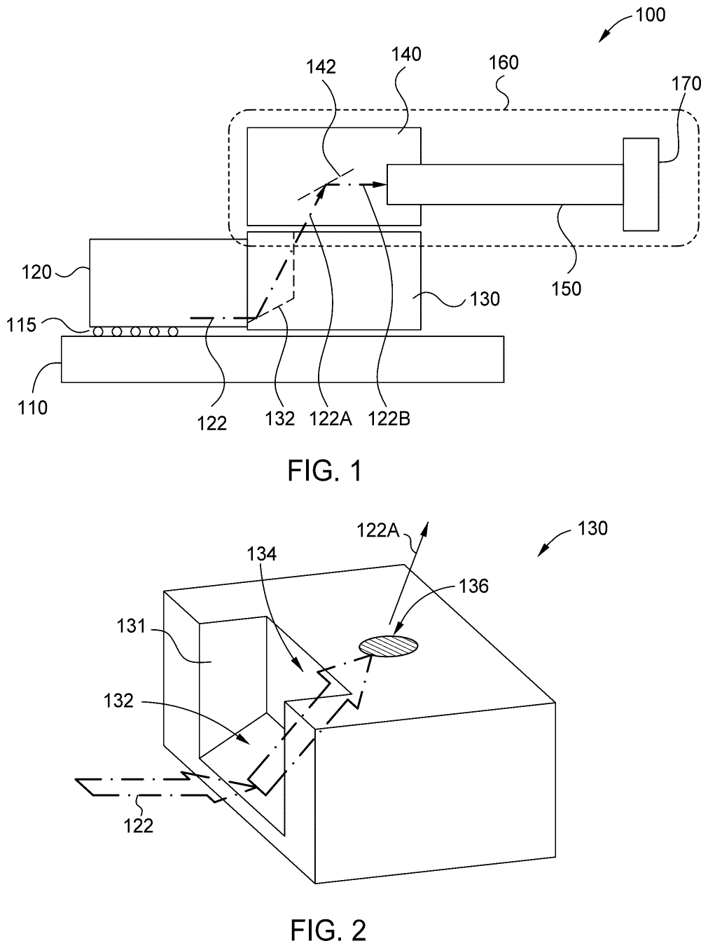

FIG. 1 illustrates an edge coupler beam deflection system, according to an example.

The edge coupler beam deflection system 100 is disposed on a substrate 110. A photonic integrated circuit (PIC) 120 is also disposed over the substrate 110. The PIC 120 is coupled to the substrate 110 via a plurality of solder bumps 115. The distance of a waveguide 122 on PIC 120 to the substrate is less than 100 μm.

The edge coupler beam deflection system 100 includes a fixed piece 130, a detachable piece 140, and a fiber ribbon array 150. The detachable piece 140 and the fiber ribbon array 150 with the optical connector 170 may be collectively referred as a fiber array unit (FAU) 160.

The fixed piece 130 includes a first mirror 132. The first mirror 132 may be a curved mirror. The first mirror 132 may be a concave mirror. The first mirror 132 is arranged at a 45° angle. In another example, the first mirror 132 is an array of mirrors when multiple channels are employed. The first mirror 132 can be formed by molding or stamping, and its reflecting surface can be metal-coated and made concave with proper curvature.

The fixed piece 130 may be referred to as an optical component or optical device or optical unit. The fixed piece 130 can also be referred to as a first optical device.

The detachable piece 140 includes a second mirror 142. The second mirror 142 may be a curved mirror. The second mirror 142 may be a concave mirror. The second mirror 142 can be formed by molding or stamping, and its reflecting surface can be metal-coated and made concave with proper curvature.

The detachable piece 140 may be referred to as an optical component or optical device or optical unit. The detachable piece 140 can also be referred to as a second optical device.

The detachable piece 140 is disposed directly over the fixed piece 130. The fixed piece 130 is disposed adjacent the substrate 110. The fixed piece 130 is horizontally aligned with the PIC 120. The detachable piece 140 is horizontally and vertically offset from the PIC 120.

Both the fixed piece 130 and the detachable piece 140 are glass molded to ensure precise manufacture tolerances and are composed of curved mirrors for beam collimation and refocusing back to the PIC 120 and a fiber core.

The fiber ribbon array 150 is coupled with a standard optical connector, e.g., multi-fiber termination (MTP) connector or multi-fiber push-on (MPO) connector and can be pre-assembled with the detachable piece 140.

Beam collimation is a process used in optics to control and manipulate the propagation of a light beam, typically to make the beam parallel or to adjust its divergence. Collimated light refers to light waves that propagate with minimal spreading, meaning the rays are parallel or nearly parallel to each other.

The main goal of beam collimation is to achieve a uniform and parallel light beam, which is desirable in various optical systems and applications, such as laser systems, imaging systems, and optical communications. Collimated beams are especially important in applications where precise control over the direction and spatial characteristics of light is beneficial.

Beam collimation can be achieved by lens collimation or collimator lenses.

Lens collimation involves using lenses to manipulate the divergence of a light beam. Placing a converging lens in front of a diverging beam can converge the rays, making them more parallel. Conversely, a diverging lens placed in front of a converging beam can spread out the rays, reducing their convergence.

Collimator lenses are specifically designed to collimate light beams. These lenses are typically plano-convex or double convex lenses with curved surfaces that focus or diverge light, depending on the application.

Collimated beams have several advantages, including improved spatial resolution, increased range and efficiency in optical systems, and reduced aberrations. The first mirror 132 and the second mirror 142 advantageously provide for collimated beams.

The fiber ribbon array 150 can be referred to as a multi-channel fiber array. The multi-channel fiber array is an optical component including multiple optical fibers arranged in a specific pattern or configuration. The multi-channel fiber array is used to facilitate parallel optical connections between different optical components. Each optical fiber within the multi-channel fiber array serves as a channel for transmitting or receiving optical signals. The fibers are arranged in a precise geometric pattern, such as a linear array or two-dimensional array. The multi-channel fiber array allows for simultaneous optical connections between multiple channels, thus allowing for high-throughput data transmission and parallel processing of optical signals. The multi-channel fiber array can accommodate a large number of optical channels within a small area, thus providing high channel density and dense integration of optical components. The multi-channel fiber array can have a 250 μm fiber pitch. The fiber pitch refers to a distance between adjacent optical channels within the fiber. The fiber pitch represents a spacing between the cores of individual channels within the fiber structure.

The edge coupler beam deflection system 100 may also be referred to as an optical engine (OE) unit. The OE unit is placed or disposed or packaged on the substrate 110. The PIC 120 is flip-chip bonded (via the solder bumps 115) so that the optical waveguide and facet are close to a top surface of the substrate 110. With this deflected-beam system, first, the fixed piece 130 can be actively aligned with the FAU 160 and fixedly attached onto the sidewall of the PIC 120 with a re-flowable index matching adhesive. A light beam from the PIC 120 travels with waveguide in-plane direction and enters into the fixed piece 130. After entering the fixed piece 130, the light beam contacts or is received by the metal-coated mirror surface of the first mirror 132 and is deflected toward the detachable piece 140 as beam 122A. In particular, the beam 122A contacts the metal-coated mirror surface of the second mirror 142 and is redirected as beam 122B toward the fiber ribbon array 150. The beam 122B enters the fiber ribbon array 150 at a low flux.

The beam 122A mode field diameter (MFD) from the optical facet of the PIC 120 will be expanded to be about 10x larger at a top point surface 136 of the fixed piece 130 to accommodate certain mechanical and angular tolerances caused by the detachable piece 140 and other assembly processes. The beam received by the detachable piece 140 matches the same beam MFD from the fixed piece 130 to minimize an optical coupling loss.

In other words, the light beam travels from the waveguide 122 thru a spot size converter (SSC) to the first mirror. The output MFD from the SSC can have a size or diameter around 9-10 um or less. Therefore, the beam size on the first mirror 132 could be maintained close to the same size or diameter if the fixed piece 130 is placed close to the edge of the PIC 120 and the beam will be expanded and collimated after the first mirror 132 and deflected upwards. When the detachable piece 140 is attached, the collimation will contact the second mirror 142 and refocus the beam back into the fiber.

The detachable piece 140 with the optical connector 170 is designed onto a surface mount mechanism associated with a substrate ring so that the FAU 160 can become detachable and can be attached whenever desired. Another advantage is that the fixed piece 130 could potentially be pre-attached at die-level before attaching to the substrate 110. The optical active alignment process can be performed by optical loop-back featured on the PIC 120 so that there is no electrical connection required for the alignment process. The die-level testing could potentially be simplified by adding such deflected-beam optics.

FIG. 2 illustrates the details of the fixed piece of the edge coupler beam deflection system of FIG. 1, according to an example.

The fixed piece 130 is a glass molded component. The fixed piece 130 defines an opening 131. A bottom surface of the opening 131 is the first mirror 132. The first mirror 132 is arranged at a 45° angle to redirect light through the back surface 134 of the opening 131 and through a top point surface 136 (or top surface area) of the fixed piece 130. The back surface 134 of the opening 131 may be filled with index-matching adhesive. The beam 122A is output from the top point surface 136 (or top surface area) and enters the detachable piece 140 where the beam 122A is redirected by the second mirror 142 disposed within the detachable piece 140.

In typical systems, the optical lens is placed or positioned or disposed on a side of the die to collimate light. However, this positioning accuracy could impact the detachability between fixed and detachable pieces. In order to ensure this accuracy, the fixed piece can be pre-attached with a golden FAU, then actively aligned by optical loop-back channels, and then attached to the PIC sidewall by an index matching adhesive.

Moreover, better optical component alignment can be advantageously achieved with the edge coupler beam deflection system 100. Edge coupler alignment refers to the process of precisely aligning optical components to efficiently couple light into and out of a device along its edges. This alignment is important for ensuring optimal performance in the edge coupler beam deflection system 100. In the edge coupler beam deflection system 100, the first optical device (the fixed piece 130) and the second optical device (the detachable piece 140) are precisely aligned to allow a light beam to efficiently travel therethrough. Proper alignment ensures that the maximum amount of light is coupled into and out of the fixed piece 130 with minimal loss. In the edge coupler beam deflection system 100, the angle of the first mirror 132 of the fixed piece 130 has been adjusted to achieve proper alignment between the fixed piece 130 and the detachable piece 140. The placement of the top point 136 has been determined to provide optimal alignment between the fixed piece 130 and the detachable piece 140. Stated differently, proper alignment is provided between the FAU 160 (including the detachable piece 140, the fiber ribbon array 150 and optical connector 170) and the fixed piece 130. As such when the FAU 160 is detachably coupled to the fixed piece 130, proper alignment can be achieved between the FAU 160 and the fixed piece 130.

The advantages of the edge coupler beam deflection system 100 include employing a large area of the top surface of the fixed piece 130 for the detachable mechanism to cooperate with. Further, the FAU techniques developed for a grating coupler (GC) can also potentially be applied with little or no modification. In a flip-chip configuration where the EC exit is very close to the substrate 110, straight coupling is difficult to implement because of the lack of mechanical clearance between the PIC 120 and the substrate 110. By utilizing the edge coupler beam deflection system 100, the gap requirement can be significantly reduced.

In an alternative embodiment, the detachable piece 140 can also be combined with the fixed piece 130 to become a permanent piece. The fixed piece 130 can be pre-assembled and permanently attached to the detachable piece 140 to become part of the FAU 160. As such, the fixed piece 130 can be actively aligned to the PIC edge-coupler and be permanently attached to accommodate tighter mechanical and assembly tolerances.

With reference to FIGS. 1 and 2, the edge coupler beam deflection system 100 can be used in various practical applications. For example, the edge coupler has various applications across a wide range of fields, especially in scenarios where high bandwidth and low loss are beneficial. Some wider bandwidth applications of edge couplers include optical communications, integrated photonics, biomedical imaging, spectroscopy, laser diode coupling, and sensing and metrology.

The edge coupler beam deflection system 100 can be used in optical communication systems for coupling light into and out of optical fibers with high efficiency and low loss. The edge coupler beam deflection system 100 can benefit long-haul communication networks, data centers, and fiber-to-the-home (FTTH) systems, where maximizing bandwidth and minimizing signal degradation are paramount.

In integrated photonics platforms, such as silicon photonics or III-V semiconductor devices, the edge coupler beam deflection system 100 can be used to couple light between on-chip waveguides and off-chip optical fibers. These platforms enable the integration of various optical components on a single chip, allowing for compact, high-performance photonic circuits for applications such as data transmission, sensing, and signal processing.

Overall, the edge coupler beam deflection system 100 finds wide-ranging applications in fields where high-bandwidth optical communication and precise light manipulation are important.

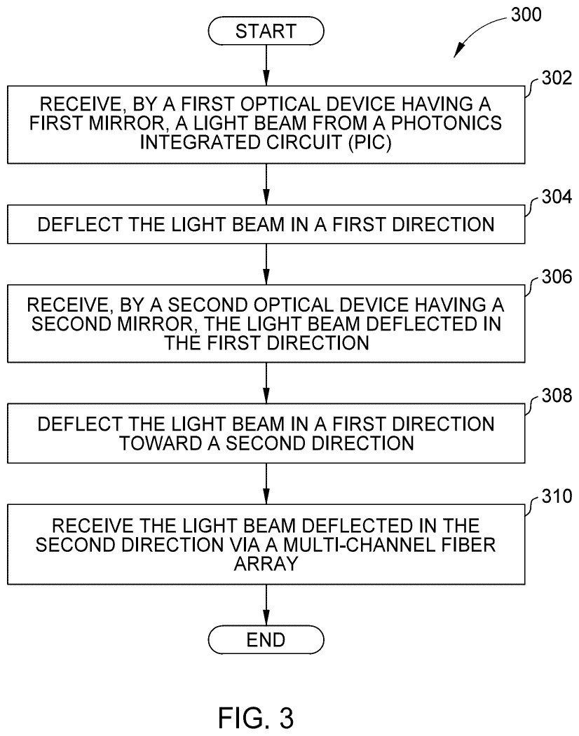

FIG. 3 illustrates a method for implementing the edge coupler beam deflection system, according to an example.

At block 302, receive, by a first optical device having a first mirror, a light beam from a photonics integrated circuit (PIC). The first mirror can be a curved mirror, such as a concave mirror.

At block 304, deflect the light beam in a first direction. The deflected light travels in a substantially vertical or upward direction.

At block 306, receive, by a second optical device having a second mirror, the light beam deflected in the first direction. The second mirror can be a curved mirror, such as a concave mirror.

At block 308, deflect the light beam in the first direction toward a second direction. The second direction is a horizontal direction. The second direction is parallel to the bottom surface of the detachable piece 140.

At block 310, receive the light beam deflected in the second direction via a multi-channel fiber array or fiber ribbon array 150. The fiber ribbon array 150 and the detachable piece 140 are collectively referred to as an FAU. The FAU is detachably coupled to the fixed piece 130.

In conclusion, edge couplers play an important role in enabling efficient and reliable optical communication and signal processing in photonic devices and systems. They are advantageously used for achieving high-performance integrated photonics for various applications, including telecommunications, data communications, sensing, and biomedical imaging. The example embodiments provide for an edge coupler beam deflection system including a fixed piece and a detachable piece. The fixed piece is disposed adjacent the PIC and the detachable piece is disposed directly over the fixed piece. The fixed piece includes a first mirror and the detachable piece includes a second mirror, where the first mirror and the second mirror are curved mirrors, such as concave mirrors. The detachable piece communicates with a multi-channel fiber array, which is coupled to an optical connector. The detachable piece and the multi-channel fiber array are collectively referred to as a fiber array unit (FAU). The FAU is detachable coupled to the fixed piece. The first mirror and the second mirror are curved mirrors to achieve beam collimation. The first mirror is at a 45° angle with respect to a bottom surface of the first optical device. The output light beam exited from the fixed piece, beam size will be expanded to accommodate higher mechanical tolerances for detachable solution needs.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
a first optical device disposed adjacent a photonics integrated circuit (PIC), wherein the first optical device includes a first mirror to receive a light beam from the PIC and deflect the light beam in a first direction;
a second optical device including a second mirror to receive the light beam deflected in the first direction and deflect the light beam deflected in the first direction toward a second direction; and
a multi-channel fiber array to receive the light beam deflected in the second direction.

2. The system of claim 1, wherein the first optical device is a fixed piece fixedly secured to the PIC.

3. The system of claim 1, wherein the second optical device is a detachable piece.

4. The system of claim 1, wherein the second optical device and the multi-channel fiber array with an optical connector define a fiber array unit.

5. The system of claim 4, wherein the fiber array unit is detachably coupled to the first optical device.

6. The system of claim 1, wherein the PIC is horizontally aligned with the first optical device.

7. The system of claim 1, wherein the second optical device is disposed on top of the first optical device.

8. The system of claim 1, wherein the first mirror and the second mirror are curved mirrors to achieve beam collimation.

9. The system of claim 1, wherein the first mirror is at a 45° angle with respect to a bottom surface of the first optical device.

10. The system of claim 1, wherein the light beam is expanded after the first mirror and refocused back to the multi-channel fiber array after the second mirror.

11. An edge coupler comprising:
a first optical device that includes a first mirror to deflect a light beam in a first direction;
a second optical device that includes a second mirror to receive and deflect the light beam in the first direction toward a second direction; and
an optical connector to receive the light beam deflected in the second direction via a multi-channel fiber array.

12. The edge coupler of claim 11, wherein the second optical device and the multi-channel fiber array define a fiber array unit detachably coupled to the first optical device.

13. The edge coupler of claim 11, wherein a photonics integrated circuit is disposed in horizontal alignment with the first optical device.

14. The edge coupler of claim 11, wherein the second optical device is disposed on top of the first optical device.

15. The edge coupler of claim 11, wherein the first mirror and the second mirror are curved mirrors to achieve beam collimation.

16. The edge coupler of claim 11, wherein the first mirror is at a 45° angle with respect to a bottom surface of the first optical device.

17. The edge coupler of claim 11, wherein the light beam is expanded after the first mirror and refocused back to the multi-channel fiber array after the second mirror.

18. A method comprising:
receiving, by a first optical device having a first mirror, a light beam from a photonics integrated circuit (PIC);
deflecting the light beam in a first direction;
receiving, by a second optical device having a second mirror, the light beam deflected in the first direction;
deflecting the light beam deflected in the first direction toward a second direction; and
receiving the light beam deflected in the second direction via a multi-channel fiber array.

19. The method of claim 18, wherein the second optical device and the multi-channel fiber array with an optical connector define a fiber array unit detachably coupled to the first optical device.

20. The method of claim 18, wherein the light beam is expanded after the first mirror and refocused back to the multi-channel fiber array after the second mirror.
